(19) United States
(12) Patent Application Publication
(10) Pub. No.: US 2025/0217876 A1
(43) Pub. Date: Jul. 3, 2025

(54) ONLINE REAL ESTATE AUCTION TICKETING SYSTEM

(71) Applicants: Jody Edwards, Simi Valley, CA (US); James R. Donnell, Simi Valley, CA (US); Stacy Elliott, Simi Valley, CA (US)

(72) Inventors: Jody Edwards, Simi Valley, CA (US); James R. Donnell, Simi Valley, CA (US); Stacy Elliott, Simi Valley, CA (US)

(21) Appl. No.: 18/401,616

(22) Filed: Dec. 31, 2023

(51) Int. Cl. G06Q 30/08; G06Q 50/163

(52) U.S. Cl. CPC G06Q 30/08; G06Q 50/163

(57) ABSTRACT

According to an aspect of the present invention, a computer-implemented method and system for conducting online real estate auctions are provided. The invention features a multi-faceted platform that includes a user interface for registration, and participation. Users can sign up and input personal, and real estate-related information. The platform stores this data as objects in a secure database. Graphical user interfaces enable users to create and host virtual auctions, solicit, and purchase tickets for these auctions, and actively participate in the auction process. The system utilizes at least one processor to coordinate these interfaces and backend processes, including a dynamic bidding management system with features like optionally extended bidding, proxy bids, and real-time notifications. Participants are provided with detailed auction information, feedback interfaces, transaction receipts, and managed escrow account services to ensure financial security and transparency in property sales.

### BACKGROUND

The real estate market, particularly the segment involving property auctions, has long been a dynamic and significant sector. However, traditional auction methods, both physical and online, often lack inclusivity, transparency, and adaptability, especially in rapidly changing market conditions. This gap highlights a crucial need for innovative solutions in real estate auctioning processes.

Existing systems for online real estate auctions are known. Prior art, such as US Patent No. KR20100005447A, discloses methods for conducting online auctions where bidders participate remotely through digital platforms. These systems typically allow for real-time bidding and transactional processes, but often do not address issues such as ticket-based access control, dynamic auction duration based on bidding activity, and integrated community contributions. Furthermore, these systems may not offer mechanisms to streamline the escrow and payment processes in a manner that enhances user experience and trust.

There remains, therefore, a need for an online real estate auction system that overcomes these limitations. Such a system would not only make property auctions more accessible and engaging but also provide enhanced security and transparency. By integrating features like ticket-based auction access, dynamic auction extension based on bid activity, and comprehensive payment and escrow management, the proposed system aims to revolutionize the way real estate auctions are conducted. Additionally, incorporating community contributions and feedback mechanisms into the system can further enhance its social impact and adaptability to user needs. This innovation has the potential to transform the real estate auction market by making it more inclusive, dynamic, and user-centric.

### SUMMARY

In view of the circumstances outlined above, aspects of the present invention disclose systems and methods for implementing software to auction real estate. This invention addresses the limitations of traditional real estate auction methods by introducing a novel and comprehensive online service.

According to an aspect of the present invention, there is provided a computer-implemented method for the online auctioning and sale of real estate, comprising: displaying a user interface for the user to sign up and input a variety of associated personal and real estate related information; storing a variety of real estate associated and personal user data as data objects in a database; displaying graphical user interfaces at a computer terminal enabling the user abilities comprising, creating/hosting virtual auctions, soliciting tickets for said auctions, browsing or buying tickets for said auctions, and attending/participating in said auctions; at least one processor aligned to coordinate these interfaces and the backend processes involved; at least one processor aligned to dynamically manage the bidding processes with features comprising optionally extended bidding, proxy bids and real-time notifications;
providing auction participants details of the auction, a user interface for feedback regarding the user's experience at the auction, a series of transaction receipts regarding the auction outcome, as well as the management of an escrow account to ensure financial security and transparency in property sale;

According to another aspect of the present invention, there is provided a system, comprising: at least one I/O device(s) associated with and communicatively connected to a terminal, arranged to store and execute a variety of data and processes related to online real estate auctions; a server processing system and client processing interfaces, communicatively connected and arranged to facilitate online real estate auctions, and at least one processor.

The system is arranged to solicit and control access to auctions via a ticket-based system, provide real-time updates/notifications to participants, dynamically adjust auction duration in response to bidding activity, and the secure management of financial transactions and escrow processes;

### Definition

In the context of this document, the term inclusive pricing’ comprises, a strategy where the sale price encompasses all related costs, such as property taxes, insurance, and transaction fees, ensuring buyers face no hidden expenses. This transparent approach simplifies the purchase process by presenting the full cost upfront. This dissuades sellers from under estimating property related fees. In the context of this document, the term ‘Creating Virtual Auctions’ comprises, a listing process that involves standard property listing inputs comprising, descriptions, price, pictures, videos, square footage, etc and also includes a number of parameters related to the formatting of the auction comprising, proxy bids, time/duration, optionally extended bidding if bids are placed in the last 10 seconds of bidding, reserve prices, and inclusive pricing.

In the context of this document, the term ‘proxy bids’ comprises, when the bidder has the option to set a maximum price that they would be willing to pay for an item and then allow the computer system to bid for them by the bid increment until someone places a higher bid than their maximum.

In the context of this document, the term ‘dynamic bidding’ comprises a bidding process where the creator of the auction sets an original bidding time window. Once this original window closes there is a temporary short window that opens for any final bids. If a new bid is entered during said temporary short window the temporary short window is reset. The auction closes once the temporary short window fully closes and the highest offer wins.

### BRIEF DESCRIPTION OF THE DRAWINGS

FIG. 1 depicts the initial user interface for sign-in/up and flows for browsing and creating auctions.

FIG. 2 depicts the auction ticket purchase and subsequent open house processes leading into the auction.

FIG. 3 depicts the overview of the dynamic bidding process and the escrow and closing processes.

### DETAILED DESCRIPTION OF THE DRAWINGS

Embodiments illustrative of the present invention are described with reference to the attached diagram, which outlines the operational flow of an online auction platform from user registration to the completion of the auction process.

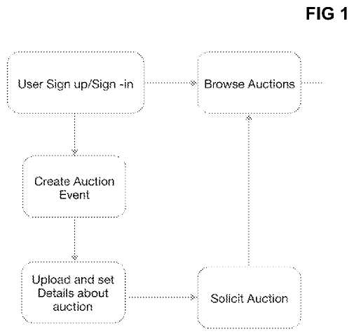

### FIG. 1—User Registration and Auction Creation

FIG. 1 portrays a user onboarding interface, constructed using technologies such as HTML5, CSS, and PHP and JQuery for the frontend and user interface. This interface initiates the interaction by displaying a prompt on a graphical user interface at a computer terminal for the user to either sign up for a new account or sign-in to an existing account, leveraging OAuth for secure authentication. The authenticated user is subsequently presented with options to browse listed auctions. A user can provide data which can be used to create an auction event involving a data intake user interface that captures detailed auction information comprising descriptions, bidding styles, photos, videos, prices, number of tickets, and inclusive pricing.

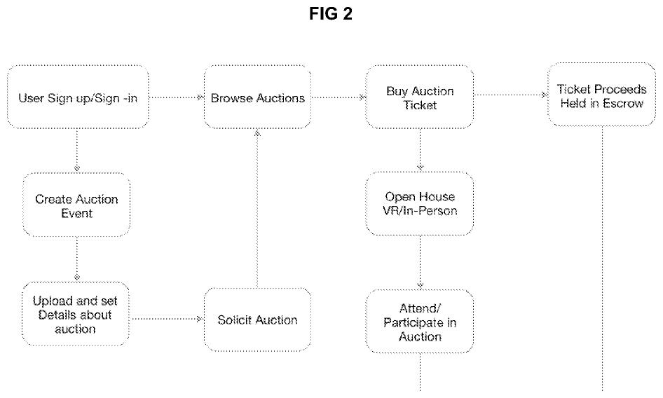

### FIG. 2—Auction Solicitation and Ticket Purchase

Depicts the flow where a graphical user interface constructed using is displayed to the user and auctions along with their associated properties are showcased and filtered across various parameters comprising property type, price, amenities, and location. Bidders may purchase ticket to bid on a property and if they win the property they are directed into a managed escrow service, adhering to standard financial regulations and basic financial security protocols.

As depicted the pre-auction phase is managed by an event scheduling module, utilizing robust calendar APIs like Google Calendar or Facebook, for non-limiting example, for in-person and virtual open houses. For virtual open houses, the system integrates advanced VR technology, employing platforms such as Unity or Unreal Engine to create detailed virtual property walkthroughs. This allows the user to explore properties in a three-dimensional space, providing a realistic and interactive viewing experience from their own location.

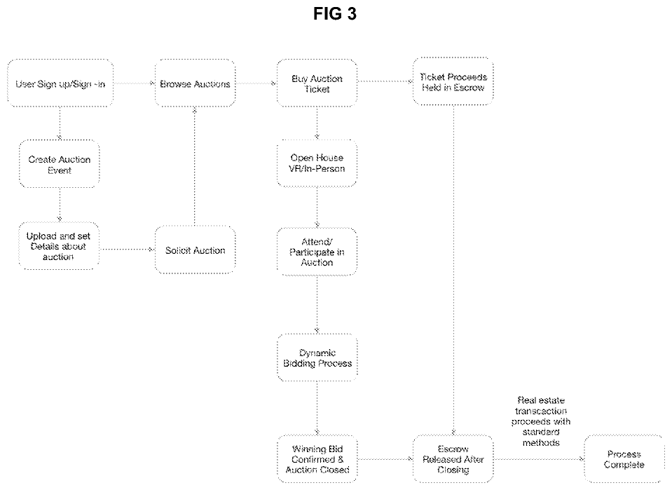

### FIG. 3—Dynamic Auction Bidding and Inclusive Pricing

FIG. 3 depicts the auction bidding phase, where users who bought an associated ticket participate in a dynamic and interactive bidding process. This interface is powered by a WebSocket-based real-time system that updates bid statuses instantaneously. The dynamic extension of the auction is managed by a time-sensitive algorithm which monitors the bid stream and extends the auction window as necessary per the rules implemented in the auction creation phase.

The concluding phase of the auction confirming the winning bid and managing the closure of the auction. The winner of the auction is directed to the escrow service, executing scripts that authorize the release of funds in compliance with transaction completion protocols.

Upon successful closure, the process transitions to a completion module, which is responsible for finalizing all post-auction activities. This module, supported by backend technologies such as Django ORM for database interactions, ensures the property transfer is reflected accurately in the system and that the financials are reconciled as per the escrow agreement. At this point the necessary documents are distributed to the buyer and seller and the transaction is carried forward as per standard real estate transactions laws and protocols.

The embodiments and operational flows herein serve to depict the flexibility and comprehensive nature of the invention, with technological configurations that can be adapted to accommodate a wide array of auction types and user preferences, all within the scope of the inventive claims.

What is claimed is:

1. A computer implemented method for facilitating a real estate auction via an online platform, the method comprising, in a server processing system: displaying a user interface for the user to sign up or sign in and input a variety of associated personal, financial, and real estate related information; storing a variety of real estate associated and personal user data as data objects in a database; displaying graphical user interfaces at a computer terminal enabling the user abilities comprising, creating/hosting virtual auctions, soliciting tickets for said auctions, browsing or buying tickets for said auctions, and attending/participating in said auctions; at least one processor aligned to coordinate these interfaces and the backend processes involved; at least one processor aligned to dynamically manage the bidding processes with features comprising optionally extended bidding, proxy bids and real-time notifications; providing auction participants details of the auction, a series of transaction receipts regarding the auction outcome.

2. The method of claim 1, wherein the method includes selling a limited number of tickets to access the virtual auction platform, ensuring inclusivity and fairness in the auction process.

3. The method of claim 2, wherein the virtual auction is extended by a predetermined time with every new bid received after an initial auction period, promoting continued engagement and competitive bidding.

4. The method of claim 3, further comprising notifying the auction winner both on the auction platform, via email, and publicly displaying the auction outcome on the auction site.

5. The method of claim 1, further comprising requiring the winning bidder to deposit the winning bid amount into an escrow trust account within a specified time frame, processing the transaction in accordance with real estate legal and financial regulations.

6. The method of claim 5, wherein the auction platform allows participants to consider home mortgages for their maximum bid price and advises ticket buyers to get pre-qualified to facilitate efficient transaction processing.

7. The method of claim 1, wherein the auction pricing includes comprehensive costs such as portions for property tax, homeowner insurance, and all title and escrow fees, providing an all-inclusive cost for buyers.

8. The method of claim 1, further including a feature of donating a percentage of gross auction proceeds, to various charities, enhancing community contribution.

9. The method of claim 1, wherein the user interface is designed using advanced web technologies including HTML5, CSS, and JavaScript frameworks for a seamless and responsive user experience.

10. The method of claim 1, further comprising the use of VR technology for virtual property walkthroughs, allowing users to explore auction properties in a three-dimensional space.

11. The method of claim 1, wherein the auction platform employs WebSocket technology for real-time bid status updates, ensuring instantaneous communication during the auction.

12. The system of claim 1, wherein the database storing real estate and user data is hosted on a secure server with encryption and data protection measures.

13. The system of claim 1, wherein the user interface for creating and hosting virtual auctions is equipped with tools for property description, image and video uploads, and bid management.

14. The system of claim 1, wherein the ticket sales for auctions are processed through secure payment gateways, with transaction details recorded and managed within the platform.

15. The system of claim 1, further comprising a backend analytics tool for assessing user engagement, feedback, and auction performance, contributing to continuous improvement of the platform.
